(19) United States
(12) Patent Application Publication
(10) Pub. No.: US 2012/0016684 A1
(43) Pub. Date: Jan. 19, 2012

(54) Public health care, method and system

(75) Inventor: Vladimir Trakhtman, New York, NY (US)

(73) Assignee: Vladimir Trakhtman, New York, NY (US)

(21) Appl. No.: 12/804,222

(22) Filed: Jul. 16, 2010

(51) Int. Cl. G06Q 50/00; G06Q 10/00; G06Q 40/00; G06Q 90/00; G06Q 30/00

(52) U.S. Cl. 705/2; 705/500

(57) ABSTRACT

An embodiment of the invention offers no medical bill public health care to provide transparency of pricing and minimal prime cost of accounting by compensating in bulk a budget or an appropriate part of the budget of a medical organization by a medical bank which expenses are compensated by retailing financial obligations among clients of said bank supposed patients of PHC. Another embodiment of the invention is to get automation of medical accounting due to averaging financial streams in respect to a virtual average patient. Yet another embodiment is to get an automated medical budget comprising a total net of secured medical accounts to collect medical parts of tax payments, other medical contributions and debts and to be used either commercially or like a budgeted source.

### CROSS-REFERENCE TO RELATED APPLICATIONS

Not applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates to insurance and business, specifically to medical ones. It relates to current U.S. Classes 705/163,705/36T,705/19,705/31, 705/14.48, 705/2 and touches, accordingly, business, insurance and tax strategies/processing/preparation.

Known commercial public health care (PHC) implies a medical insurance sandwiched between medical services and clients of the insurance in order to help ill clients to pay huge medical bills. In accordance with a typical contract a client and/or an employer of the client pays regular payments (premiums) to compensate occasional medical bills paid by the medical insurance in the case of such occasional event as an illness of a client.

Known budgeted PHC is a part of a budgeted social security system. It is based on programs Medicaid and Medicare to pay medical bills of poor, old and disable people for the cost of a budget fed by tax payers.

Both commercial and budgeted options of PHC suffer from high cost of current medicine. It limits the number of individual/collective clients of commercial PHC and appears a heavy load of budgeted PHC. But curing patients by the best medical technologies, applying modern medical equipments and medications is expensive objectively. There are as well objective non medical (commercial and technological) factors to make medicine expensive. Among them, for example, there are:

Unavoidable necessity of commercial medical organizations and insurances to get income

Unavoidable low efficiency and high cost of a budgeted bureaucracy.

Such factors are evident and objective but there are almost invisible and non-objective factors to define high cost of medical pricing. Existence of such factors could be explained by the lack of transparency of PHC. If correspondent information is reveled, it would help to improve the situation. But it is a problem which differs from a bureaucratic one to be resolved by more detailed medical reporting, regulating tax payments etc. Instead, it is a scientific problem which demands an integrated look at PHC.

If some blocks (components, articles, essences etc.) are used in consecutive order, all blocks together create a system with its own attributes not equal to ones of each initial blocks. Single blocks give the system of blocks their attributes and the system gives the blocks its own integrated attributes. Entire system appears more than a sum of blocks.

Historically, human society is developing separately in respect to different aspects of PHC. Commercial medicine, insurances, budgeted social security are developing to keep each its own purpose and interest while a supposed common purpose and interest (which could be satisfied by the best technology to coordinate together different parts of PHC) is not taken into account.

For example, look at such known element of medical technology as a medical bill. It is applied by a medical organization to register pricing a medical service and is processed by an insurance (or budgeted social security) to compensate medical expenses of a medical organization to cure a patient. Each partner of this technological chain keeps its own interest in respect to the medical bill and the fact appears beyond attention that the medical bill is actually a signal of the entire system of PHC which gives the system its own attributes. Partners of PHC look at numbers written on the bill with the interest either to pay less or to get more money. Nobody thinks about a common aspect of billing technology.

Thanks to the current invention, the same medical bill is recognized like an important independent factor of PHC which demands to invert up side down entire financial technology of medical services. It happens, billing technology defines the cost of PHC not less than medicine proper. This almost invisible factor of PHC does not depend on a patient, her/his illness, an insurance and a medical service separately but pricing of entire PHC increases if the technology of billing is improper. A medical bill is recognized by the present invention like a side effect, which makes entire system of PHC more expensive. The disadvantage of known PHC is medicine costs more thanks to improper billing technology.

The patent application ‘Tax Insurance Method, and System’ #12/154,553 from May 22, 2008 of the same author touches some aspects of so-called inverse business. It is about an activity to serve prime customers (as medical patients of a medical service) for the prime cost. But this patent application is mostly about budgeted social security and does not touch the case of commercial PHC which demands income undoubtedly. This theme waits for new inventions.

### BRIEF SUMMERY OF THE INVENTION

The present invention is developed to prepare a long-term project to improve national system of public health care. It includes embodiments of an immediate and distant implantation. An embodiment of the invention offers no medical bill public health care to provide transparency of pricing and minimal prime cost of accounting by compensating in bulk a budget or an appropriate part of the budget of a medical organization by a medical bank which expenses are compensated by retailing financial obligations among clients of said bank-supposed patients of PHC. Another embodiment of the invention is to get automation of medical accounting due to averaging financial streams in respect to a virtual.average patient. Yet another embodiment is to get an automated medical budget comprising a total net of secured medical accounts to collect medical parts of tax payments, other medical contributions and debts and to be used either commercially or like a budgeted source.

### BRIEF DESCRIPTION OF THE SEVERAL VIEWS OF THE DRAWINGS

FIG. 1—the block scheme of serving a single patient by known PHC

FIG. 2—the block scheme of PHC in accordance with the present invention

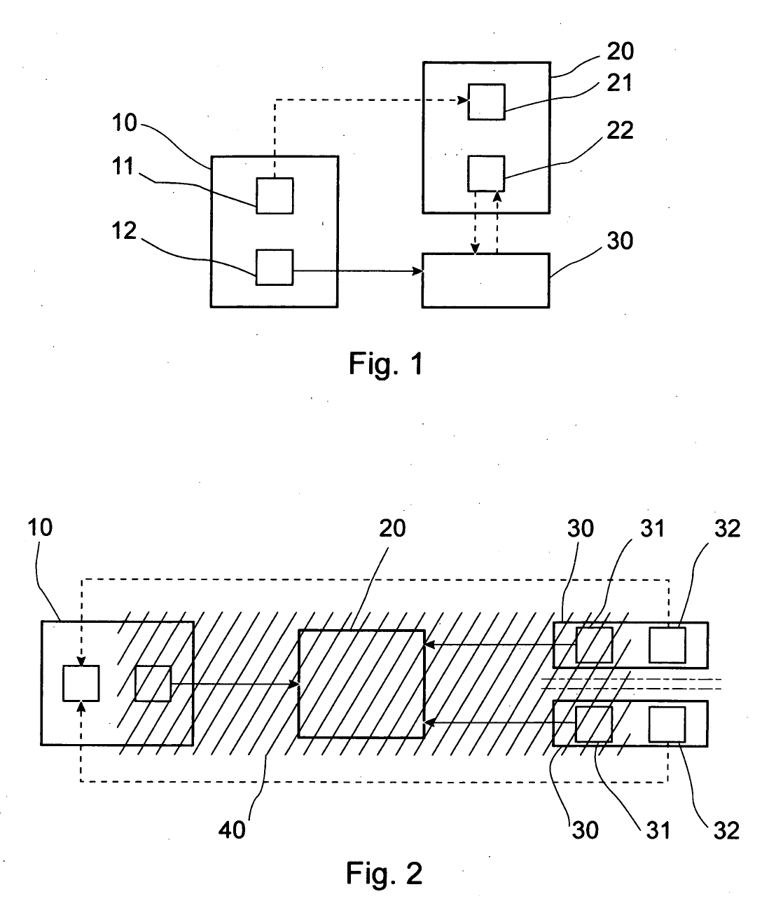

On the FIG. 1:

10—patient like medicine+financing medical services

11—medical aspect of the patient

12—financial aspect of the patient

20—medical organization

21—medical services

22—medical accounting

30—medical insurance

On FIG. 2:

10—medical organization

11—medical services

12—medical accounting

20—medical bank

30—patient like medicine+financing medical services

31—medical aspect of the patient

32—personal medical account of the patient

40—a shaded zone of regular financing of PHC

### DETAILED DESCRIPTION OF THE INVENTION

Recent Medical Reform in USA demands every citizen (every business) to become a client (a collective client) of a medical insurance. But the insurances are expensive. Many people and a lot of small businesses have no money to buy medical policies. Poor and disable people are paid by budgets and expensive social medicine appears a heavy load of society. So, known (PHC) costs more but does not serve society properly. It means, the plan to recruit more clients of current (not improved) PHC either could not be realized or may ruin budgets of all levels. To improve PHC, let discuss shortly different aspects of this problem.

1. Let state a medical office/hospital is a commercial enterprise to serve medical needs of society. This enterprise has a budget which includes expenses and income. The budget should be fulfilled by medical patients or medical insurances of the patients, other sources. Billing procedure is initiated by a medical office/hospital. A medical bill reflects the cost of a medical service of a patient estimated by the medical office/hospital.

But the medical office/hospital cannot estimate exactly its own financial interest just after the visit of a patient. It is because the financial interest of said medical office/hospital depends on factors connected with a concrete visit of a concrete patient and not connected with the visit of said patient. Among the items to be supported financially by a patient but do not connected directly with a visit of the patient to a medical organization, there are:

Maintenance of medical real estate

Maintenance of medical equipments

Necessity to renovate both the real estate and equipments

All aspects to touch a department of medical human resources

Market of medications

New medical technologies, supporting high medical qualification of specialists

Etc., etc.

Such factors could be estimated financially by an annual budget. Let think just the budget defines proper financial needs and sources to compensate the needs of the medical organization. If so, entire financial documentation (and medical bills) should be coordinated with the budget.

What about a medical bill based on an occasional visit of a patient, it appears a real source of uncertainty and non transparency of medical accounting. It may bring either loss or profit both a hospital and a patient/insurance. All cases are not good for society. Society needs all partners of PHC to be satisfied properly. If it is not done, it would be the disadvantage of current medical practice which demands another billing philosophy and an improved billing technology.

2. Let state a medical insurance is a commercial enterprise to help individual and/or collective clients to pay medical bills. This enterprise has a budget (fulfilled by premiums of clients). It includes expenses and income of the insurance. The premiums are counted to overcome natural uncertainty of such rare (for young clients) or not so rare (for old clients) but at both cases random events as illnesses of a human being. Each illness demands curing and creates a medial bill. Uncertainty of the illness creates equal uncertainly of appearance and the bill and an amount of the bill.

The point is uncertainty cost more in comparison with certainty. It is compensated by premiums of clients that include an additional amount to compensate defense of the insurance from the risk of uncertainty. The more value of uncertainly the more additional cost of the insurance and the more cost of a medical service. It means, there is an invisible additional internal insurance of insurance inside every medical insurance. If actual risk is smaller than an anticipated one, income of a medical insurance is increased improperly. If regular items of a budget of a medical organization like maintenance, a lecture about new methods to cure a cancer etc. are present among expenses registered by a medical bill, it automatically increases said improper additional income of insurance like a payment for a risk when there is no risk. If said regular expenses of a hospital are not included into a medical bill of a patient, the question should be put what is the source to compensate the expenses?

A regular price is paid by a patient or an insurance of the patent calculated as if all medical expenses result from such random events as an illness but it is an illusion based on absence of proper information. Both the insurance and the patient are not informed which items are included into a medical bill and which ones are not included. If regular expenses are processed like random ones, it results in additional payments to compensate a risk when there is no risk. It is the disadvantage of known system of PHC. It is a systematic disadvantage not to be improved by an insurance or a hospital separately. Entire billing technology should be improved to avoid this disadvantage.

3. Current medical bill is definitely an occasional or random event but the sense of this randomness is far from an illness of a human being. It is rather a permanent problem or a constant illness (or a problem) of a medical organization which budget should be fulfilled each year. But an insurance takes into account such permanent problem like a random event to happen with a patient, not with a medical organization.

The more said regular component of a medical bill, the more misunderstanding the medical insurance which calculates premiums of clients on the base of wrong information while clients of the insurance pay more premiums increasing income of the insurance without a risk for the insurance.

4. As a rule, a regularization of a random insured event like an artificial (hand made) auto collision, false illness etc. is legally estimated as a crime to be seriously punished, especially when a budgeted source is applied to compensate expenses. It means a medical bill with regular expenses of a medical organization to be paid by an insurance like a random event, is a masked crime until correspondent information is represented by said medical organization and proper recalculations are produced in respect to premiums of clients.

5. Budgeting could be interpreted like an anonymous insurance to resolve collective non profitable tasks of society for the cost of taxation. While budgeting is executed mandatory and regularly, this kind of insurance serves regular expenses by regular premiums (tax payments) smoothing financial picks by averaging financial streams. It means budgeting represents an alternative to known commercial insurance based on averaging instead of calculating random events. In PHC, the budgeted principle may be more appropriate thanks to said unavoidable regular components of medical expenses.

6. PHC could be interpreted like a system to connect patients with medical services and to connect a budget of a medical organization with sources to satisfy the budget. Now, both connections are synchronized by a patient. Satisfying a budget of a medical organization is fulfilled by small parts represented by medical bills. Correspondent financial transactions are switched on by patients. A medical organization issues a stream of bills to compensate expenses to serve the patients. It is the situation which resembles a shop but a patient buys a kind of a medical service without discussions and pays for this service the price estimated by a medical organization together with an insurance without a discussion with a patient also. Essential discussions may happen between a medical organization and an insurance only but both are sellers in respect to a buyer—patient.

So, a medical bill is created independently from a patient and premiums to be paid by the patient—client of an insurance are created independently from the patient. It means, this shop applies the patient like an article to be sold to a buyer, the same article—patient. It looks like an abnormal commerce because the buyer of this shop looks like an item or an article of this commerce.

An interpretation of PHC would be more appropriate to believe a patient is a regular, even if a specific partner of this business. The more commercial activity of patients inside PHC, the better would be both a medical service and a medical commerce. But it touches a human being, not an illness of the human being. This interpretation puts a barrier between a patient and an illness of the patient. A role of the patient is increased by the interpretation, a role of an illness is decreased. It becomes clear that it has no sense to retail illnesses during medical commerce—like it is done by current medical bills. Retailing should touch supposed patients—clients of an insurance. Because there is no randomness among the clients. It leads to the idea to satisfy regular expenses of medicine by regular clients of an insurance. What about random illnesses, they appear almost beyond medical accounting at all.

7. If a technology produces the number of similar articles or a similar service is organized to deal in a lot of similar customers, such technology/service belongs to the domain of mass-servicing. Known system of mass-servicing is oriented to produce typical operations in bulk or by packaging deals among similar items and in accordance with rules and regulations about producing similar technological operations.

Medical patients represent variety of medical cases but a financial aspect of medicine looks like mass-servicing, rather a wholesale, not a retail technology. If an insurance takes the obligation to pay medical bill of clients, the insurance may fulfill this duty without taking into account detailed medical and technological information about a concrete patient and a service provided in order to cure the patient.

If a hospital is organized to cure a stream of patients, there is no necessity to take into account every step of the hospital to do this when medical expenses are counted. A job of the hospital may be estimated financially by its technology and by loading of the technology.

The hospital has a budget that could be satisfied in bulk without preparing personal medical bills. Retailing medical services ‘by ilnesses’ could be substituted by a kind of wholesale with entire amount of all medical services of all patients cured during a budgeted term. It follows from a known method to minimize prime cost of a technology of mass-serving.

It is a financial technology to be adjusted in respect to possibilities of a manufacturer of an item or a provider of a service in conditions when many external random calls of individual customers create a regular stream of similar calls. It does not matter that each patient meets a specific medical trouble and gets a specific medical service. Whatever medical service results in a similar for all medical cases financial procedure. All services for all patients should by paid.

Compensating a medical budget in bulk looks like a wholesale procedure to minimize the prime cost of medical accounting. It has sense if to look at all patients together they are partners of this business. Like the partners, said patient could understand medical services much better than like independent and occasional visitors.

So, if there is the problem of PHC when so many people cannot buy medical policies, let us minimize the prime cost of medicine by known ideas of wholesale commerce under the condition patients should become valuable partners of medical commerce.

8. A chain of connected technological elements each with specific functions could be interpreted as a system to produce an item or to provide a service. Such system could be described by the set of qualities or traits just at the same degree the idem produced by the system or the service provided by the system could be described by the set of qualities or traits.

The point is a technological element of low quality defines a correspondent quality of entire system. So, a train with a defective car brings a catastrophe to all cars. A patient of PHC resembles said defective car of a train because a commercial role of the patient inside PHC is equal to zero right now. Current Medical Reform is directed to improve PHC but nothing is offered to increase a commercial role of patients like partners of commercial medical businesses (medical insurances and medical organizations). It happens when a huge amount of medical money is collecting for the cost of medical tax payments.

On FIG. 1 the scheme is drawn of a known medical service provided by PHC in respect to a single patient. The patient 10 is represented on FIG. 1 by the block 11 (a random visitor of a medical organization 20) and by the block 12 (a payable client of a medical insurance 30). The medical organization 20 is represented on FIG. 1 by a medical block 21 to cure patients and a financial block 22 ready to write medical bills.

Becoming ill, the patient 10 appears a customer 11 of the medical block 21. After curing the patient, the financial block 22 of the medical organization 20 writes a correspondent medical bill sending the bill to the medical insurance 30. Because the insurance 30 is fed by regular premiums of the payable client 12 and similar premiums of other clients, the insurance either pays the bill or begins a discussion with said medical organization. It is shown on FIG. 1 by arrows of connections between blocks 22 and 30 oriented into different sizes. Dotted lines on FIG. 1 show random events like appearance of the patient at a medical organization and writing a correspondent medical bill.

So, a technology based on a patient begins with uncertainty like an illness of the patient and creates further uncertainty as a medical bill. Let us rewrite this scheme taking into account ideas of mass-servicing. It implies the vision of a regular stream of patients on the place of many occasional patients. Even if every single patient catches randomly a random illness, the stream of many patients is not a random event. On the contrary, it is a regular stream of different patients with different illnesses. A financial service of such regular stream may be organized regularly. It explains why medical insurances and medical organizations are regular institutions. They are based on regularity of the stream of sick patients.

On FIG. 2, the scheme of FIG. 1 is rewritten to represent regularity of medical accounting of the stream of random patients of PHC. A zone of regular financing is represented on FIG. 2 by shaded block 40. It includes a financial block 12 of a medical organization 10 connected with a medical bank 20 which keeps medical accounts 32 of medical clients 30.

Medical organization 10 has a budget. It includes technological expenses of the medical organization and current loading the technology with patients. It could be estimated finally at the end of a budget term. The budget is satisfied by the medical bank 20

The block scheme on FIG. 2 is put on the base of three embodiments of the present invention. Actually, all of them represent a unite embodiment divided into separate parts for continuing implantation. The main purpose of the invention is to get automation of PHC not touching medical technology. But it undoubtedly touches a lot of aspects of entire society and cannot be fulfilled momentarily.

The first embodiment of the invention represents minimum which could be realized soon. It does not demand a transformation of a current medical insurance into a medical bank. It does not need creating personal medical accounts of clients. But developing no bill medical technology is a must.

It could be based on a contract of said medical insurance 20 and medical organization 10 (or many similar medical organizations) to keep a wholesale medical commerce which comprises satisfying in bulk technological medical expenses and a proper pricing of loading the technology by patients. It would be no medical bill accounting which essentially simplifies financing, makes this proccess more transparent and decreases expenses of both medical organization 10 and insurance 20. Actually, it is a kind of an inverse business to be defined by rather regular and internal factor of given technology than random external circumstances like an occasional illness of an occasional patient. This novelty does not touch a medical aspect but helps planning medical services. It is useful as such and helps to organize in future a soft financial control of PHC (see other embodiments of the invention, below). It helps also getting proper financial information provides more cheap medical service. It is the way to recruit more clients of PHC.

In principle, a budget of a private medical organization is under private responsibility but the invention implies developing and implantation of typical templates of medical budgeting and reporting like steps to keep PHC under said soft administrative control.

Commercial medicine is a business oriented to get more income. But getting the more income the more medical troubles, it looks immoral. A medical business looks much better getting the more income the less medical troubles around. Unfortunately, such inverse business appears beyond technological possibilities of direct or regular marketing. To keep a medical commerce and to support a medical moral, it appears a serious problem which demands inverting a business technology.

Another novelty of the present invention a medical bank (insurance) appears a transparent commercial partner of a medical business while budgets of both are tightly connected. If a commercial interest of medicine is to get more income, the interest of the bank is limited by an inverse interest of its clients. The point is transparency of accounting permits representing to public opinion whatever details. If a medical bank (insurance) does not do this, another bank (insurance) does. It is the way market would support inverse commercial strategy to take less from a pocket of a single client under the condition the number of clients could increase.

Among different possible nets of PHC, a scheme of a financial organization (bank or insurance) to serve a sole medical organization leads to the most simple accounting. It includes initial technological expenses and the factor of loading the technology by patients. Such accounting is applied to keep financing technological conveyers. To estimate financial obligations of a final client at the end of the conveyer, it is enough to take a budget of medical organization, add expenses of a medical bank and to divide the amount into the number of clients. It would be the price of a imagined or virtual middle client processed by PHC for a budgeted term and just the same price would be paid by a real client of PHC.

If a sole financial organization serves many medical organizations, budgets of all of them are summarized to get a budget of said financial organization and to count the cost of servicing said virtual middle client to be gotten by dividing said budget to the number of clients.

If a medical organization serves clients of many financial institutions (banks or insurances), the budget of said medical organization should be shared among the financial institutions by dividing the budget of medicine to the number established by a formula to take into account such factors as the number of patients—clients of an institution, the number of visits of such clients and other factors like a kind of an illnesses of a client.

The financial technology implies crediting medicine by a financial organization during a budgeted term and final recalculation at the end of this period. It implies at least a budget-term partnership of clients and medical business to serve the clients and opens the way to offer clients different financial plans and individual contracts to establish payments as a client wants.

The same scheme could serve budgeted (social) medical clients and does this much better and cheaper than a regular Social Security Administration does. Like a commercial structure, the commercial financial institution is more effective and flexible. It could easily keep all rules and regulations of current legislation in respect to admitting for social security and it would serve social clients like commercial ones—keeping a commercial interests.

The same no medical bill accounting technology should be applied to serve social patients for the price of the same virtual meddle client. Payments of social security should be taken in bulk, on the base of the same rules of wholesale commerce.

Replacing social medical duty to market opens possibilities to keep commerce around social medicine. It is because commercial medicine pays tax and a part of this tax belongs to the same social medicine. A medical bank could produce the only paper work concerning taxation of all commercial parters of PHC and this paper work minimizes real transferring financial tax streams. It is the resources to make budgeted financing cheaper and it means, PHC would becomes cheaper.

Replacing social medicine into market would be useful by many other reasons. Besides such positive aspects like effectiveness and shrinking bureaucracy, this novelty helps automation of PHC because automation of one unite system better than automation of two different systems. It is the way also to create more effective schemes of social regulation the sphere of medicine (see below).

Social clients are paid by a federal and/or state and/or municipal budgets. Replacing social medicine into market opens the possibility of a commercial support of social clients. It would be useful in respect to automation. It would be useful in respect to humanization of society. If a client of social medicine gets equal commercial rights with regular clients of a bank, it brings a lot of new possibilities because the social client would feel freedom of personality. And he feels responsibility to keep the freedom.

The embodiment of the present invention offers an essential step on the way to replace social medicine into market. It is the step to give social medical clients a kind of personal medical property, just the same property which should be done entire population.

If a person pays medical tax why this property should belong to bureaucracy? It is the property of who pays medical tax and it is the property of PHC at a time. If society decides to help poor or disable or old people giving them social medical help, let society gives the same people correspondent amounts of money like the same special private medical property. It would make the society a bit more united, a bit more rich and a bit more ready to get automation of PHC. And it gives less useless medical bureaucracy which does not cure patients and which could not be automated like commercial PHC could.

The present invention offers said secured private medical property to be organized like life-term personal medical accounts of all people of country without exceptions. Each account should be associated with a social security number of a person. It would be the account to collect medical tax payments of the person, premiums paid for the profit of a medical insurance, social medical contributions, other medical payments and debts. On FIG. 2, the accounts are shown like financial blocks 31 associated each with a correspondent patient 30.

A person becomes a client of a medical service (insurance, bank) by associating her or his personal medical account with a financial medical organization (insurance, bank). Of course, the person could change the organization. The organization takes obligations to keep correspondent medical financing of the client. A person—client of a medical organization could (under definite legal limitations) take private initiative to transfer the personal medical property (amount on the account) partially or entirely in order to resolve medical problems of other people in accordance with her or his own will: could help members of family, friends etc., make medical gifts, credit medical payments, inherit medical property or to hand inheritance down etc.

It is the way to get a united commercial background of automated PHC. It looks like . infrastructure of a united system of medical commerce and it does not matter that some people pay medical bills by themselves when other people get social medical help. A united technology should serve all people. This situation resembles applying electricity. If a person does not pay electric bills it does not mean electric company should destroy an electric net. Without the net a social help to pay for electricity of some clients would become much more expensive. Current situation with social medical help looks like some electric pillars are sawn out and the service is fulfilled manually for the cost of tax payers. It has no sense.

This embodiment needs a serious political will to be realized because the idea of the embodiment is a technological and political one at a time. It is the idea to make a financial aspect of a medical service the field of as more personal responsibility of a person as it could be possible and it is the idea to make a technology to realize the responsibility as cheap as possible.

Now people pay a medical tax like a duty of an anonymous and impersonal application. Let people pay the same medical tax to increase own personal medical property and to keep in order correspondent medical credit histories. It is the way people would feel medical security is kept by hands of the same people. People would pay with pleasure additional voluntary medical payments of personal medical security and to save medical property on secured accounts. It would be a kind of self insuring. So, offered property will make people more responsible in respect to PHC.

It is the way also to smooth a huge contrast between big medical money focused by bosses of PHC and current clients of PHC without commercial rights in PHC but used by PHC like articles of a business. Numerous personal medical accounts would represent equal big money scattered among the accounts of population. Big focused medical money of medical bosses could be compared with big scattered medical money of population. Society gets an instrument of impersonal objective regulation the sphere of PHC by comparing medical taxation and a combined amount on personal medical accounts of population.

It would be the regulation to be realized similarly on different levels. On a federal and/or state and/or municipal level the same comparing medical taxation with personal medical accounts would result in a small changing the rate of medical taxation. On the level of a medical bank it would be a concrete commercial credit or even a single act of philanthropy. In any case, it would be a regulation to make from entire system of PHC a kind of a living system able to compensate even a part of external challenges.

Appearance of personal medical accounts would become something like a small social and at a time commercial revolution to get more capitalism and better medicine. Society becomes much more humane with this novelty. People would feel themselves more stable and saved with a medical property on personal accounts. It is the way to reconcile people with even a part of taxation which appears the instrument to unite people and to give people a real power.

Simplifying financial medical technology appears a base ground of the embodiment of the present invention to get an automation of medical accounting. Currently, medical accounting demand a lot of professionals prepared by universities. Thousands of ‘medical’ financial specialists do nothing is sense of medicine but make medical pricing two times more expensive thanks to necessity to support themselves. Automation on the place of this useless medical army, it would be another kind of a small revolution of PHC to be done thanks to the present invention. It is the way to make medicine cheaper and pricing more transparency. It is the way to apply a united net of private medical accounts to organize a valuable control and a proper social regulation of financing medical services including minimizing medical tax payments. Of course, it would be a distant phase of developing PHC.

Firstly, it implies a medical bank to become a center of of medical accounting. Such novelty should be based on partnership among medicine and a financial organization able to provide payable clients to the medicine. A unite holding is supposed to combine interests of medicine and financing the medicine under a unite management.

A medical bank like the center of the holding is offered to be based on insurance (a mutual help of people) based on averaging financial streams. This procedure does not contain a financial risk and does not need sophisticated computations. It opens the possibility of automation The system of PHC comprises:

A bank unite including data processing apparatus

Means connected to said apparatus for inputting instructions

Said apparatus having regulatory requirements of banking and financing stored therein;

Means for inputting instructions in said apparatus to produce banking, financing and controlling operations as well as calculating and recalculating financial requirements and other parameters;

Means for inputting instructions in said apparatus for establishing appropriate operations

Means for inputting instructions in said apparatus to keep control against said regulatory requirements

Means connected to said apparatus to execute said instructions comprises:
A unit to produce banking financing and controlling operations
Means to receive appropriate payments of clients
Means to receive budgeted transactions
Means to calculate tax payments of partners of PHC like budgeted transactions
Means to recalculate proper financial parameters
Means connected to said apparatus for displaying current results of servicing
Means connected to said apparatus for announcing and marketing

Wholesale commerce between the medical bank and medicine (satisfying medical budgeting in bulk) simplifies medical accounting because numerous details of a medical service appear beyond attention of this financial technology. It makes the technology essentially cheaper and opens the way of automation by devices to keep such financing without an excessive payable personal.

This technology implies a long-term partnership of all participants of PHC (medicine, insurances, patients—clients of the medical bank, authorities of all levels). It is the way to keep a cheap medicine of a high quality.

The medical bank could redirect tax payments of all commercial partners of PHC to compensate budgeted payments and to support clients of medical social security by local efforts. It is the way of a specific partial privatization of social medical security by a commercial PHC, getting a friendly partnership of commercial and budgeted medicine.

So, the present invention supports the number of useful and important improvements:

Offers life-term medical personal accounts

Makes people valuable partners of medical commerce

Creates conditions of voluntary medical tax payments and investments into PHC

Replaces the most part of budgeted (social) medical technologies into a market.

Gets criteria of a political control of PHC

Carries out no medical bill technology of PHC

Offers mutual financial help of people (insuring) by averaging financial streams

Increases transparency of pricing medical services

Minimizes the prime cost of medical technology

Recruits new personal clients of PHC

Recruits new low budgeted collective clients of PHC among small/middle businesses

Offers automation of medical accounting

1. A method of public health care to provide no medical bill financial technology to minimize prime cost and improve transparency of pricing comprises:
compensating regular expenses of a medical organization (below—budget of medicine) by a correspondent budget of an associated bank (below—budget of banking);
retailing financial obligations of said budget of bank among clients of public health care;
controlling budgets of both medicine and banking by legislated and managerial efforts.

2. A method of claim 1 comprises:
establishing said budget of medicine on the base of medical technology realized by the medical organization;
sandwiching the bank between said medical organization and supposed patients of said medical organization, clients of the bank comprising:
establishing said budget of banking by wholesale settlement to satisfy the budget of medicine or a appropriate part of said budget;
establishing retail contracts with said clients of the bank in order to satisfy the budget of banking by contribution of said clients;
executing the budgets and contracts;
representing by the bank and medical organization appropriate financial and medical information.

3. A method of claim 2 to develop and introduce typical templates of a budget of medicine taking into account statical (constructive) and dynamic (productive) parameters of the medical technology including expenses, income and the possibility to optimize medical technology by a managerial art.

4. A method of claim 2 to control income of the medical organization legislatively.

5. A method of claim 2 to credit the medical organization by the bank during a budgeted term including financial recalculating at the end of the term.

6. A method of claim 1 to develop and introduce typical templates of financial and medical information to support said no medical bill financial technology.

7. A method of claim 2 to simplify the technology of medical accounting by creating a holding of PHC to combine together a medical organization or many medical organizations and the only (united) medical bank under a united management of PHC comprises creating the budget of the bank on the base of the sum of medical budgets and counting the price of serving a virtual mean patient (the price to be a client of the medical bank) for a budgeted period by dividing the budget of bunking to the number of clients of the medical bank.

8. A method of claim 2 for the case when a medical organization is associated with the number of medical banks and/or has additional sources to compensate the budget of medicine comprises counting a correspondent financial duty of a bank by dividing the budget of medicine or a part of the budget to the number established by a formula to take into account such factors as the number of patients—clients of a bank, the number of visits of such clients and other factors like a kind of an illnesses of a client.

9. A method of claim 2 to establish a contract among said medical organization and bank to execute financing a medical organization by said medical bank comprises executing said contract for the price to be added to initial financial obligations of the bank to keep a budget of medical organization.

10. A method of claim 2 to establish a contract between said bank and clients to get a fund of risk supported by additional payments comprising:
establishing rules and regulations to keep a fund of risk;
executing said contract.

11. A method of claim 2 to establish possibilities for clients of the bank to pay premiums by parts during a budget term.

12. A method of claim 2 for social clients sponsored by a municipal and/or state and/or federal budgets comprising paying the bank by said budgets the sum equal to the number of said social patients multiplied by said cost of servicing a virtual mean patient comprising:
representing by correspondent authorities rules and regulations to accept said social clients;
representing by the bank appropriate information about said social clients;
establishing conditions of crediting or paying by parts during a budget term;
executing said payments;

13. A method of claim 12 to compensate said social financial obligations with planned and not paid actually tax obligations of the partners of PHC as said bank and/or medical organizations.

14. A method of claim 2 to accept investments of the clients to keep medical commerce of PHC and to get an appropriate income.

15. A system of public health care to provide automation of medical accounting, minimal prime cost of servicing and transparency of pricing on the base of no medical bill financial technology comprises:
a medical bank (below—bank) for wholesale financial settlement to satisfy a budget of a medical organization or organizations (below—medicine) or an appropriate part of the budget and further retailing expenses among clients of the bank comprising:
a bank unite including data processing apparatus;
means connected to said apparatus for inputting instructions;
said apparatus having regulatory requirements of banking and financing stored therein;
means for inputting instructions in said apparatus to produce banking, financing and controlling operations as well as calculating and recalculating financial requirements and other parameters;
means for inputting instructions in said apparatus for establishing appropriate operations;
means for inputting instructions in said apparatus to keep control against said regulatory requirements;
means connected to said apparatus to execute said instructions comprises:
a unit to produce banking financing and controlling operations;
means to receive appropriate payments of clients;
means to receive budgeted transactions;
means to calculate tax payments of partners of PHC like budgeted transactions;
means to recalculate proper financial parameters;
means connected to said apparatus for displaying current results of servicing;
means connected to said apparatus for announcing and marketing.

16. A system of claim 15 to produce medical accounting by means of said medical bank.

17. A method of public health care to optimize medical service of population and replace the most part of social medicine into a market comprises establishing life-term medical personal accounts of population comprises:
collecting on said accounts personal medical taxation, medical premiums and debts;
keeping personal medical and correspondent financial life-term history;
estimating current personal medical credit-worthy;
accepting amounts on said accounts like a special medical private property comprises:
the possibility of transferring under definite conditions the amounts or parts of the amounts on said accounts to correspondent accounts of other people;
keeping under definite condition a commerce on this base.
keeping global and/or local regulations to fulfill exhausted medical accounts for the cost of medical part of taxation and/or other contributions

18. A method of claim 17 to keep a federal and/or state and/or municipal level of feed back comparing the sum of incomes of commercial partners of PHC like banks and medical organizations in comparison with the sum of amounts on personal medical accounts of correspondent group of population comprising a regulation of correspondent tax payments.

19. A method of claim 17 to transfer medical components of tax payments of commercial partners of PHC to feed said personal medical accounts of populations comprises a political regulation of the distribution of said transferring among different groups of people.

20. A method of claim 17 to associate said personal medical accounts with social security numbers of people.
